(19) United States
(12) Patent Application Publication
(10) Pub. No.: US 2026/0352918 A1
(43) Pub. Date: Nov. 5, 2026

(54) ADAPTIVE ADVERTISEMENT INSERTION FOR LOW-ENGAGEMENT ZONES

(71) Applicant: DISH Network Technologies India Private Limited, Bengaluru (IN)

(72) Inventors: Yogish PD, Bengaluru (IN); Mamidi Chenna Keshava Manikanta, Bangalore (IN)

(73) Assignee: DISH Network Technologies India Private Limited, Bengaluru (IN)

(21) Appl. No.: 19/664,283

(22) Filed: Apr. 30, 2026

(30) Foreign Application Priority Data
May 1, 2025 (IN) 202541042419

(51) Int. Cl. H04N 21/44; G06Q 30/0251; H04N 21/442; H04N 21/466; H04N 21/81

(52) U.S. Cl. CPC H04N 21/44016; G06Q 30/0269; H04N 21/44222; H04N 21/4662; H04N 21/812

(57) ABSTRACT

Systems, devices, and methods are described for adaptive insertion of advertisements with respect to low-engagement zones in media content. Some embodiments may include an automated process performed by a playback device. The automated process may include presenting a media content from a media platform, collecting user interactions corresponding to the media content, determining a low engagement zone in the media content, and inserting a promotional advertisement related to another media content available via the media platform. Some embodiments may include a media platform server receiving user interaction information related to a media content presented by a playback device, determining engagement zone segmentation based on the media content or the user, providing the engagement zone segmentation to the playback device. Other examples and related devices and methods are also disclosed herein.

### CROSS REFERENCE TO RELATED APPLICATIONS

The present application claims priority to Indian Patent Application No. 202541042419 filed on May 1, 2025, and entitled “ADAPTIVE ADVERTISEMENT INSERTION FOR LOW-ENGAGEMENT ZONES,” which is incorporated in its entirety herein by reference.

### TECHNICAL FIELD

The following generally relates to media content platforms, and more particularly, to systems, devices, and automated processes to determine a user’s engagement with media content and promote alternative content available from the media content platform in low engagement zones.

### BACKGROUND

Media content platforms, also referred to as streaming platforms, media platforms, content platforms, or just platforms, may include media aggregation and/or distribution services which allow users to access and consume media content. Media content may include audio, video, text, or other media, may include analog and/or digital media files, and may be referred to more simply as content. For example, media content may include television shows, movies, movies, live broadcasts, and/or the like. Media platforms may provide content over any suitable medium, such as over-the-air, a network, satellite, or the like. In many cases, media platforms are online services that provide digital content to users. The media platform services and content may be accessible via various devices, such as smartphones, smart TV’s, computers, set-top boxes (STB), software application, and/or the like. A media platform system may include the computer server(s) providing media content to the users and the playback devices which receive the media content and present it to the users.

A media platform may deliver media content from a central server or from other content sources to the user devices, which may then present the media content to the user. The content may be stored on the server, in cloud storage, or the like, and may be streamed to the user devices in small segments. Media platforms may use timestamps in media content to synchronize and manage the delivery of audio, video, and other media elements in real-time. Timestamps mark specific points in the media, allowing the platform to organize and control playback. For example, video files typically have timestamps to track frames and scenes, ensuring that the video plays in the correct order and at the right speed. When a user plays a video or audio stream, the platform uses these timestamps to fetch and deliver the right data chunks at the appropriate times, preventing playback issues like skipping or lag. Timestamps may also be used in adaptive bitrate streaming, enabling functions such as seeking (fast-forwarding or rewinding), skipping ads, synchronizing subtitles or captions, and/or the like.

A media platform can offer a broad range of media content to users, from one or more sources. In some cases, a user may not be able to discern different sources of content when interacting with the media platform. A media platform may offer a wide range of entertainment options to users, for example live television, sports-related content, movies, music, documentaries, etc., through subscription-based or ad-supported models. Media platforms benefit from prolonged user engagement with the media platform, for example allowing additional opportunities for advertising and corresponding revenue therefrom, continued interest in the user in paying for a subscription to the platform, and so on. In some cases, the media platform may be able to identify a particular user, for example via authentication methods, accounts, IP address, or by any other suitable method. The media platform may track a user’s preferences with respect to interest in various content types, advertising preferences, watch history, length of typical viewing session, and/or the like.

A user may have differing levels of engagement with media content, where the higher level of engagement is more likely to retain viewers than a lower level of engagement. Low-engagement portions or zones in a media content may lead to the user abandoning – whether temporarily or permanently – the media platform for another platform. Existing media platforms fail to adaptively address user engagement with media content in a real-time manner.

A substantial desire therefore exists to build systems, devices, and automated processes that can determine and adapt to user engagement in media content to retain users on the platform for a longer period of time.

### BRIEF SUMMARY

Various embodiments relate to systems, devices, and automated processes to determine a user’s engagement with media content and promote alternative content available from the media content platform in low engagement zones.

Various embodiments may include an automated process performed by a playback device having a processor, an interface to a media platform server, and a user interface. The automated process may include presenting, to a user of the playback device, a first media content from the media platform server, collecting, via the user interface, a plurality of interactions of the user corresponding to the first media content, transmitting, to the media platform server, the collected user interactions, determining, using the processor, a low-engagement zone in the first media content, and inserting, in response to determining the low-engagement zone and during presentation of the first media content, a promotional advertisement related to a second media content available via the media platform server.

Various embodiments may include a playback device configured to communicate with a media platform server over a network, the playback device having a user interface, a processor, and a non-transitory storage, wherein the non-transitory storage includes computer-executable instructions that, when executed by the processor, perform an automated process. The automated process may include presenting, to a user of the playback device, a first media content received from the media platform server, collecting, via the user interface, a plurality of interactions of the user corresponding to the first media content, transmitting, to the media platform server, the collected user interactions, receiving, from the media platform server, an engagement zone information, determining, using the processor and according to the engagement zone information, a low-engagement zone in the first media content, and inserting, in response to determining the low-engagement zone and during presentation of the first media content, a promotional advertisement related to a second media content available via the media platform server.

Various embodiments may include a media platform system comprising a media server configured to communicate with a playback device over a network, the media server having a processor and a non-transitory storage, wherein the non-transitory storage includes computer-executable instructions that, when executed by the processor, perform an automated process. The automated process may include providing, via the network, a first media content to the playback device, receiving, from the playback device, a user interaction information, wherein the user interaction information describes a plurality of interactions of a user with the playback device corresponding to playback of the first media content, determining an engagement zone segmentation of the first media content based on the user interaction information, wherein the engagement zone segmentation identifies a low-engagement zone of the first media content, and providing, via the network, the engagement zone segmentation to the playback device.

These and other example embodiments are described in increasing detail below.

### BRIEF DESCRIPTION OF DRAWING FIGURES

FIG. 1 is a block diagram illustrating an example arrangement of components associated with a media platform system, according to various embodiments.

FIG. 2 illustrates an exemplary process for analyzing user engagement, according to various embodiments.

FIG. 3 illustrates an exemplary process for determining a promotional advertisement, according to various embodiments.

FIG. 4 is a flow diagram illustrating various processes executed by various devices in the media platform system to increase user engagement, according to various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

Existing media platforms fail to effectively promote other shows, movies, events, or other possibly more engaging media content available via the same media platform, leading to reduced viewer retention in low-engagement portions of media content and missed potential revenue and audience-building opportunities. Existing media platforms also fail to leverage the opportunity to gather insights on whether users are engaged with media content or whether users engage with recommended content.

To the contrary, a media platform according to various embodiments described herein may place engaging recommendations to help retain viewers. Various embodiments may promote other media content that a user (e.g., viewer) may find engaging, retaining the user’s attention on the media platform for an extended period of time and thus earning additional ad revenue, building audience and subscription based, among other benefits. Various embodiments determine a user’s engagement with a media content, for example based on learned behavior patterns associated with each particular user and/or based on engagement zone information learned from a larger group of users with respect to the media content. Various embodiment may present a promotional advertisement to a user prior to their departure from the platform, and the promotional advertisement may be based on the user’s interests. A user’s engagement level may be determined, for example, based on the user’s interaction with the media content. User interactions and respective metrics may include frequency (or amount) of changing channels, frequency of skipping of content, frequency of seeking, pausing, or the like, and patterns of user interactions may be recognized and used to determine an engagement level of the user.

According to various embodiments, a media platform may use viewer engagement analytics to place promotional advertisements (ads) for platform-specific content, like upcoming TV shows, movies, or sports events, in low-engagement zones. The promotional advertisements may be inserted into the media content prior to a time in which the user may discontinue use of the media platform. The promotional advertisements may be chosen based on a user’s interests. Various embodiments may monitor user interaction with these recommendations to refine promotional advertisement placement strategy over time.

A promotional advertisement or platform‑specific advertisement may refer to an advertisement that promotes media content available via the same media platform server 104, such as upcoming TV shows, movies, sports events, or other media content that can be accessed through the media platform. A promotional advertisement may be determined using a recommendation algorithm that selects content corresponding to an interest of the user, such as a preferred genre, actor, team, channel, or viewing time, as indicated by the user’s viewing history, demographic information, explicit preferences, or other user interaction information. Accordingly, the promotional advertisement may correspond to an interest of the user and may be selected to retain the user’s engagement with the media platform server 104 rather than allowing the user to move to media content from a different platform.

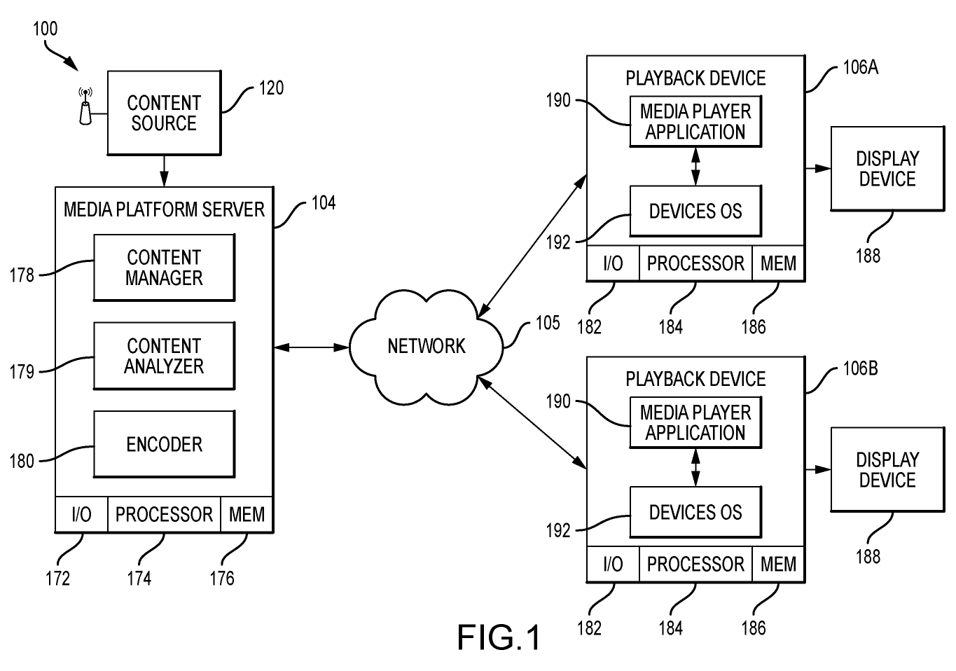

Referring now to FIG. 1, a media platform system 100 may include a media platform server 104 and one or more playback devices 106A-B. A playback device may be referred to as a media player device herein. In some embodiments, the media platform server 104 may receive media content from one or more content sources 120, and may transmit that media content through a data network 105 to the playback devices 106A-B in the form of a media stream that can be received, processed, and displayed by the playback devices 106A-B. The media platform system 100 is an example of the type of system that can provide a variety of media content, such as streaming video, television content, music, and/or the like, to one or more playback devices 106A-B. The media platform system 100 can be used to implement the process flows described further below. The media platform itself may be considered the backend serving content to the frontend playback devices 106A-B, and the media platform server 104 may be referred to as a backend server herein.

In general, the content sources 120 can be any type of media content source, including media providers, content aggregators or distributors such as a cable television system operator, a direct broadcast satellite (DBS) system operator, or simply a network service provider or the like. The media platform server 104 may process the received content into a suitable format streaming or otherwise providing to the playback devices 106A-B. To facilitate this, the media platform server 104 may include an I/O 172, a processor 174, and a memory 176. Additionally, the media platform server 104 may include a content manager 178, a content analyzer 179, and an encoder 180. Other embodiments could provide the features described herein using conventional computing machinery (e.g., physical or cloud based servers) by parties that may or may not be interested in re-distributing the received content, as desired.

In some embodiments, each of the playback devices 106A-B includes a combination of hardware and/or software needed to receive, process, and play the video streams received from the media platform server 104. For example, each of the playback devices may include an I/O 182, a processor 184, a memory 186, and may include, be coupled with, or otherwise operable to communicate with a display device 188, speaker, and/or other output device. Furthermore, each of the playback devices 106A-B may include a media player application 190 and a device OS 192 residing in memory 186 and being executed by the processor 184. In some embodiments, the media player application 190 may present the media content. In some embodiments, the device OS 192 may provide underlying functions such as decoding and decrypting media content, tracking user interactions, performing engagement analysis, implementing algorithms or other engagement information provided by the media platform server 104, providing such information to the media platform server 104, and/or the like. In some exemplary embodiments, each of the playback devices 106A-B can be implemented with any suitable computing device. Such devices may include an integrated display device 188, or may be coupled to a separate display device 188. In some embodiments, the playback devices 106A-B may include a set-top-box (STB), a client media receiver, a smart tv, or the like.

In accordance with the embodiments described herein the media platform system 100 is implemented to monitor interaction of one or more users with media content and determine whether a user has a low engagement with the media content and is likely to switch to another media content, for example another media content available from a third-party media platform separate from the platform operating the media platform server 104. When such low engagement is detected, the one or more components of the media platform system 100 may operate to promote other media content available via the media platform server 104 to encourage continued engagement of the user with the media platform 104. In some embodiments, promoting other media content may include inserting or otherwise providing a promotional advertisement that advertises other media content available via the media platform server 104 that the user might be interested in. The promotional advertisement may be inserted during or prior to a detected low-engagement zone in a current media content and may result in the user continuing to consume content from the media platform server 104 instead of switching to another media platform or provider.

To facilitate this, the playback devices 106A-B may be configured, via software and/or hardware, to monitor one or more interactions of a user with the media content, promotional advertisement, and/or the like. A user interaction may include playing, pausing, rewinding, fast forwarding, skipping, stopping, rewatching, and/or any other suitable playback operation with respect to a media content, promotional advertisement, or the like being presented by the playback devices 106A-B. In some embodiments, the user interactions may be tracked or otherwise monitored by software instructions stored in the memory 186 and executed by the processor 184. User interactions may be received in any suitable manner, for example received via I/O 182 in response to a media content, advertisement, or the like that is currently being presented, was presented in the past, or will be presented in the future (e.g., and indication of the next media content to play). The I/O 182 may include a user interface such as a graphical user interface, a remote control receiver, a network interface, and wireless transceiver, and/or the like. In addition, the playback devices 106A-B and/or media platform server 104 may include any suitable combination of hardware and/or software configured to analyze user interactions with media content and/or advertisements, determine an engagement level of the user with respect to the media content, determine an impact of a promotional advertisement, determine one or more algorithms operable to determine the engagement level of one or more users, updating recommendation algorithms, and/or the like. In some embodiments, the one or more algorithms may be customized for each user based on the interactions of that particular user.

In some embodiments, a playback devices 106A-B may be further configured to determine a low‑engagement zone in the first media content using only locally available information. For example, the playback device 106A may, using processor 184 and the user interaction information collected via I/O 182, analyze one or more metrics such as a frequency of skipping, seeking, pausing, stopping, or changing channels during playback of the first media content. Based on the collected user interactions, the playback device 106A may determine that a portion of the first media content corresponds to a low‑engagement zone during which the user has a sufficiently low engagement that the user is likely to discontinue playback of the first media content or select other content. In such embodiments, the playback device 106A may insert, in response to determining the low‑engagement zone and during presentation of the first media content, a promotional advertisement related to a second media content available via the media platform server 104.

In some embodiments, the media content received by the media platform server 104 from the content sources 120 may be analyzed as appropriate to identify the program contents. For example, the content analyzer 179 can be implemented to analyze audio and/or video content in the media content. Such a system can be used to recognize advertisements (e.g., commercials) or other portions of the underlying content, for example scenes, scene types, transitions, or other characteristics of the media content which may correspond to or affect user engagement. In some embodiments, the content analyzer 179 executes, for example using the processor 174, a software application that performs the analysis based upon the audio and/or video content received. In various embodiments, content analyzer 179 may consider average zero crossing rate, average spectrum, spectral flatness, prominent tones across a set of frequency bands, bandwidth and/or any other characteristics of the audio or video signals of the media content. Some embodiments may perform a temporal analysis in addition to or in place of frequency analysis. Such a temporal analysis could, for example, identify peak (or peak RMS) values in the time domain signal to find beats (e.g., in music) or other times between peak values that can uniquely identify or categorize the content. This temporal analysis could be combined into a fingerprint or signature in any way, or could be considered separately from other factors. Many different audio and video fingerprinting or other automated analysis programs could be used in any number of embodiments.

The extracted content data may be compared to data previously stored in a database, as appropriate, to identify portions of content in the program stream. Scenes or scene types, for example, can be recognized when the audio portions of the program stream contain similar data to known audio data stored in a database. Such a database may make use of conventional database software, or the database may be a custom database developed to store content recognition data, as desired. Such a database may reside on the same computing hardware as the media platform server 104, or separate computing resources could be provided, including any type of cloud-based computing resources.

In some embodiments, the content analyzer 179 is configured to recognize scene changes in the underlying content. When a different scene is identified in the content, the content analyzer 179 may attempt to recognize the scene based upon digital analysis of the audio and/or video. If the scene or a similar scene already exists in the database, then information about user engagement with respect to such a scene can be recorded and/or retrieved from the database or elsewhere. If the scene is not recognized, then a new entry in the database may be created to identify subsequent occurrences of the same or similar scenes. To that end, a digital “signature” or “fingerprint” of the scene is stored for subsequent analysis. Content may be initially recognized based upon information supplied by human data entry (e.g., crowdsourced data, or data entered by a technician), or by data supplied by a content source (e.g., an advertiser, broadcaster or network), and/or from any other source as desired. Content analyzer 179 is therefore able to identify various aspects of the received media content through analysis of the underlying audio, video content, text-based (e.g., subtitles) content, or the like.

In many implementations, content identification is performed by the content analyzer 179 in parallel for multiple channels, media content, media streams, or the like that may be simultaneously received for content aggregation, for collection of advertising data, or for any other purpose. A distributor/aggregator, for example, may encode the extracted signals for distribution on a digital network, for aggregation and redistribution of signals over a DBS or cable distribution system, for generating content stored on a RSDVR or VOD service, or for any other purpose. Content identification may be performed while the content is being processed for redistribution. Alternately, content may be stored for subsequent analysis, as desired.

In some embodiments, the content analyzer 179 can perform content analysis in parallel with the encoding provided by the encoder 180. The encoder 180 can encode live broadcast signals and other media content for adaptive streaming over a data network 105 such as the Internet, via broadcast via cable, direct broadcast satellite, terrestrial broadcast, wireless transmission, and/or the like. The encoder 180, for example, can be used to encode signals into a suitable format for broadcast via cable, DBS, or the like, for streaming via the Internet, cellular network, or the like, or any suitable combination of format and network. Such broadcasts may be ultimately received by playback devices 106A-B via the network 105 or the like. In some embodiments, the encoder 180 suitably encodes programs contained within signals from the content sources 120 into one or more adaptive streams that each representing a media program in its entirety, but which may contain different bit rates, frame rates, resolution, and/or other levels of quality.

Typically, each stream is made up of smaller segments that each represent a small portion of the media program content with a single data file. Each stream is typically encoded so that segments of the different streams are interchangeable with each other, often using a common timing index which may be referred to as a timestamp. This allows a client playback devices 106A-B to mix and match segments from different streams to create a media stream that effectively adapts as network conditions or other conditions change. The timestamps also facilitate identification of locations in the media content to insert advertisements and may be used to identify various user engagement zones in the media content, such as a low engagement zone and high engagement zone. Since the segments are typically stored as separate files, segment requests may take the form of conventional hypertext transport protocol (HTTP) constructs (e.g., HTTP “get” instructions) or the like. Such constructs are readily routable on network 105 and can be served by conventional CDN or other web-type servers, thereby providing a convenient mechanism for distributing adaptive media streams to a variety of different client devices on network 105, such as playback devices 106A-B.

Other embodiments may use different encoders for the encoder 180. Still other embodiments may omit the encoding function entirely and perform audio analysis or other content recognition separately from the distribution function. Since many distributors already receive program signals for encoding, there may be an economy of scale in performing the content recognition function at the same time. Other embodiments could nevertheless use different encoding or streaming structures or techniques, as desired, or content could be equivalently aggregated and/or broadcast via satellite, cable, terrestrial broadcast, non-adaptive media stream and/or the like. As noted above, it is not necessary that the analyzed content be re-broadcast or re-distributed by the analyzing party in all embodiments. It may be sufficient for many purposes to simply gather data for recognizing advertisements or other portions of the content, for analyzing or further processing information about the recognized advertisements and/or for taking other actions as desired without necessarily re-broadcasting or redistributing the content itself.

Content manager 178 is provided to manage and distribute electronic program guide (EPG) data and/or other information about the programs that are distributed within the media platform server 104. In some embodiments, the content manager 178 may be implemented to process and manage information relating to advertisements or other portions of the content stream such as engagement zones, to associate actions performed by the viewer and/or the playback device based upon the content of the stream and/or advertisements, and/or for other suitable purposes. For example, the content manager 178 may associate, store, and/or provide information about various engagement zones of a particular media content, content type, or the like. For further example, the content manager 178 may determine, store, and/or provide user-specific information, for example determining an algorithm or parameters for an algorithm indicating an engagement level of a particular user based on the action(s) taken by the user with respect to a media content, a promotional advertisement, or the like.

The data maintained by the content manager 178 could include channel or other such information and timing information about each entry so that the particular content can be readily identified. Other embodiments may use different identification data, such as distributor or network information, or any other information as desired. Some implementations may incorporate conventional EPG data (e.g., data obtained from a vendor or other source), while other implementations may use channel and time so that portions of a program can be individually identified. Commercials and other advertisements, for example, could be referenced by their channel and broadcast time so that additional actions unique to those advertisements could be enabled. Other embodiments could use different timing references (e.g., references to MPEG presentation time stamps (PTS) in the underlying content, references to event anchors in the content itself, and/or any other timing references) as desired.

In various embodiments, data including information obtained from the content analysis and user engagement analysis is provided to the playback devices 106A-B. This data could be formatted in any manner. In various embodiments, data could include action data and/or identification data as tags or the like in an XML-type format. In various embodiments, engagement algorithms may be transmitted as trained machine learning models (MLMs), behavioral algorithms, clustering algorithms, time series analysis algorithms, variables and parameters therefore, and/or the like. Many other embodiments could incorporate any number of additional or alternate features to take advantage of the real-time user engagement determination features provided by the media platform system 100.

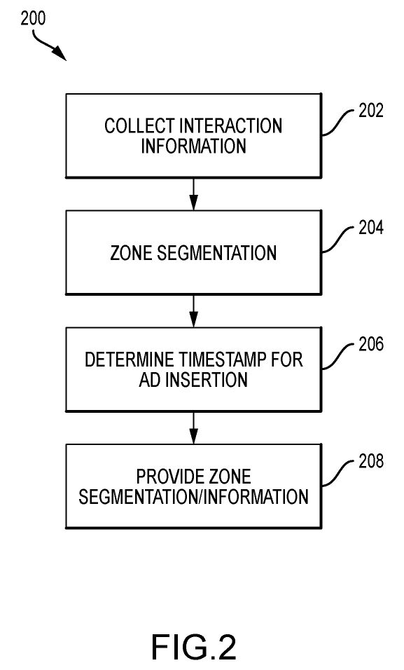

Referring to FIG. 2, an exemplary user engagement method 200 is illustrated. The user engagement method 200 may be implemented by the media platform server 104, for example. In some embodiments, one or more steps of the user engagement method 200 may be implemented or otherwise supported by the playback devices 106A-B. The user engagement method 200 may be configured to collect user interaction data, determine engagement characteristics of various portions of the media content, and provide corresponding information to the playback devices 106A-B to facilitate detection of low user engagement and promotional ad insertion. As used herein, the terms engagement zone information, engagement zone segmentation, and engagement zone segment information may be used interchangeably to refer to information that identifies one or more engagement zones of a media content, such as low‑engagement zones, for example using timestamps, segment identifiers, algorithms, fingerprints, or other data structures.

At step 202, the media platform server 104 may request, receive, and/or otherwise obtain user interaction information from one or more playback devices 106A-B. The interaction information (or data) may correspond to one or more actions a specific user or group of users performed with respect to a media content being played or otherwise presented by a playback device. The interaction information may include any suitable information that describes the actions of a user with respect to playback of a media content, such as metrics including watch time, pause time, amount and/or frequency of skipping, etc., actions/events such as skip forward, fast forward, skip back, rewind, seeking, pause, stop, rewatch, exit, information related to changing channels or other content streams, and/or the like. The interaction information therefore describes a user’s interaction with a particular media content and therefore with the media platform server 104 providing the media content.

In some embodiments, step 202 may include receiving user interaction information corresponding to multiple users, where each set of user information corresponds to a unique user. The received multiple sets of user interaction information may each correspond to a particular media content, such that the multiple sets of user interaction information describe how a group of users interacts with the particular media content. In some embodiments, step 202 may include receiving multiple sets of user interaction information corresponding to a particular user, wherein each set of user interaction information describes how the particular user interacts with multiple different media content. Step 202 may include obtaining information about how multiple users interact with a single media content, how a single user interacts with multiple different media content, and/or any other suitable combination.

At step 204, the media platform server 104 may determine engagement zone segmentation. In some embodiments, step 204 may include determining an engagement zone segmentation of a particular media content (e.g., a specific episode of a TV series) based on the received user interaction information. In some embodiments, step 204 may include determining an engagement zone segmentation, for example formula-based, for a particular user based on the received user interaction information. The engagement zone segmentation may include information identifying a low-engagement zone of the particular media content. A low-engagement zone may be a portion of a media content during which the user is likely to have a sufficiently low engagement with the media content such that the user may discontinue playback of the media content. In some embodiments, the low-engagement zone may be determined relative to other portions of a media content, such as a high-engagement zone where a user is highly engaged, and/or may be based on thresholds with respect to one or more metrics determined with respect to a user’s interaction with the media content such as a number of channel changes, pause events, rewind events, and/or criteria that indicate user disinterest, for example within a defined time period. In some embodiments, multiple sets of user interaction information may need to be analyzed to obtain a certain level of confidence in determining engagement zones.

In some embodiments, the engagement zone segmentation (also referred to as engagement zone information) may include any suitable indication of an engagement level of one or more users with respect to one or more media content. The engagement zone segmentation may identify a low-engagement zone in a media content using one or more timestamps, for example identifying a beginning and end of a low-engagement zone, a start of a low-engagement zone, or any other suitable indication of low-engagement. The engagement zone segmentation may include a timeline of user behavior patterns indicating disinterest, and/or a timeline within the media content.

In some embodiments, the engagement zone information may include an algorithm, variables or other parameters for an algorithm, a trained machine learning model, and/or the like. For example, the playback devices 106A-B may include one or more algorithms configured to identify low engagement of a user based on the collected user interactions, and the engagement zone information determined by the media platform server 104 may include parameters, variables, node weights, or the like that adapt or otherwise update the algorithm(s) performed by the playback devices. For further example, the engagement zone information may include a machine learning model trained, during step 204, by the media platform server 104 or other suitable computing device and executable by one or more playback devices 106A-B to identify low engagement of a user, and/or node weights for such a trained machine learning model that can be incorporated into a machine learning model executed by the respective playback device 106A-B.

In various embodiments, the engagement zone information may include information corresponding to a particular media content for a particular user, corresponding to a particular media content for a larger group of users (e.g., based on demographic, for the entire user base, etc.), corresponding to a plurality of media content (e.g., all content, based on genre, etc.) for a particular user, and/or any other suitable combination of groupings of one or more users and one or more identifiable media content.

Step 204 may include the use of collaborative filtering (based on behavior of users with similar preferences), user-based collaborative filtering, item-based collaborative filtering, matrix factorization, content-based filtering, clustering algorithms, behavioral analysis algorithms, anomaly detection algorithms, classification algorithms, survival analysis, or the like.

In cases where the media platform server 104 has sufficient information for a particular user, for example sufficient history of user interactions with one or more media content, the engagement zone information may include an algorithm as described above, tailored to the particular user. Such algorithm may be provided to the respective media player device 106A-B for the user and the device may monitor interactions of the user and determine engagement levels based on the received algorithm. In cases where the user is new to the platform or the media platform server 104 otherwise doesn’t have enough information for a user, the engagement zone information may be based on a more global analysis of multiple users for a particular content, and the engagement zone information may correspondingly determine portions of each particular content (e.g., episode of a TV series) that globally or based on demographics (or the like) have low engagement. In some embodiments, the media platform server 104 may determine or update both a user-specific engagement zone information (e.g., algorithm) and a more general engagement zone information (e.g., based on interactions of multiple users for a particular content), based on the received interaction information from step 202.

Accordingly, in some embodiments, the engagement zone information may comprise an engagement zone segmentation of a first media content, wherein the engagement zone segmentation identifies a low-engagement zone of the first media content. In some examples, the engagement zone information may identify a low engagement zone using timestamps corresponding to the media content. In some embodiments, the engagement zone information may comprise an engagement zone algorithm (or parameters, variables, etc. therefore) corresponding to a first user, wherein the engagement zone algorithm is operable to identify, based on the collected user interactions, an increased likelihood of the first user selecting a media content from a source other than the media platform server 104.

Step 206 may include determining one or more timestamps (or other indications of portions of a media content or segment identifiers) that identify determined low engagement zone(s) of a media content. In some embodiments, step 206 may be implemented or otherwise included as part of step 204. Statistical analysis or other suitable techniques may be used to determine relevant timestamps in a media content that suitably segment the content into low engagement and/or other zones. For example, techniques such as content analysis (e.g., scene changes), genre/structure analysis, metadata analysis, or the like may be implemented. Such timestamps may not be necessary in cases in which the engagement zone information is a user-specific algorithm, in which case low engagement zone may be detected based on user interactions instead of or in addition to observing timestamps in a media content.

In some embodiments, step 206 may optionally include determining a timestamp in the media content suitable for insertion of a promotional advertisement. Statistical or other suitable analysis may be used to identify the timestamp for ad insertion. For example, analysis may include content analysis (scene changes, speech/audio analysis), content genre and structure analysis, metadata analysis, timed text analysis, or the like. In some embodiments, the timestamp for ad insertion may be within a low engagement zone. In some embodiments, the timestamp for ad insertion may be prior to a low engagement zone, for example to promote another media content available from the platform server 104 just before or otherwise sufficiently before the actual low engagement zone where a user may switch to media from a different platform or otherwise disengage from the current platform server 104.

Step 208 may include providing, for example via the network 105, the engagement zone segmentation information to the playback device of the user, to all playback devices, or any other suitable combination of playback devices 106A-B, for example based on whether the engagement zone segmentation is specific to a user, is more generalized to a group of users, or the like. Step 208 may include providing the determined user engagement algorithm to the respective playback device. In some embodiments, the determined timestamp for insertion of a promotional advertisement by the playback device may be included with the engagement zone information provided by step 208.

In some embodiments, the user engagement method 200 may include providing a second media content to the playback device 106A-B of a user, receiving a second user interaction information (e.g., step 202) from the playback device that describes user interactions corresponding to playback of the second media content, and determining (or updating) an engagement zone segmentation based on the user interaction information for the first and second media content, where the engagement zone segmentation may be a user engagement algorithm identifying low-engagement behavior of the user. Accordingly, in some embodiments, the algorithm may be determined after observing user interactions of a particular user with respect to multiple media content.

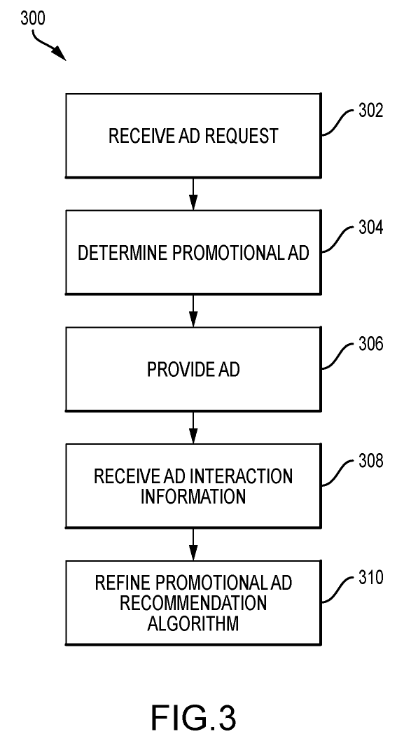

Referring to FIG. 3, an exemplary platform promotion method 300 is illustrated. The platform promotion method 300 may be implemented by the media platform server 104, for example. In some embodiments, one or more steps of the platform promotion method 300 may be implemented or otherwise supported by the playback devices 106A-B. The platform promotion method 300 may be configured to receive a request for a promotional advertisement, determine a targeted promotional ad placement, provide the promotional ad, receive interaction information corresponding to an interaction of the user with respect to the promotional ad, and refine an advertisement recommendation algorithm accordingly.

At step 302, the media platform server 104 may receive an advertisement request from a media player device 106A. The advertisement request may include a request for a promotional advertisement to insert into a media content due to detection, by the media player device 106A, of a low-engagement zone (whether based on a user algorithm and/or based on a more general segmentation of the media content itself).

At step 304, the media platform server 104 may determine a promotional ad to place in the playback of the media content. A promotional ad may include an advertisement intended to retain a user’s engagement (whether current or future engagement) with the media platform, for example with the platform server 104. The promotional ad may correspond to an interest of the user, may be determined using existing or yet to be invented advertisement recommendation algorithms, or the like. To contrast, traditional ads are often paid-for and do not focus on promoting the platform. The promotional ad may include an advertisement for other content available via the same platform server 104. In some embodiments, the promotional ad may be for the same medium of content provided to the media player device 106A, for example satellite to satellite, internet streaming to internet streaming, or the like. Some embodiments may include advertisements for content available via alternative medium. Rules may be used in step 304 to avoid disruptive ads unrelated to the platform’s offerings, prioritize promoting upcoming shows, movies, or sports events, or the like. Promotional ad may highlight live events later in the day (e.g., sports or premieres) that may be of interest, may recommend on-demand content that matches the user’s viewing history or popular platform offerings, or the like. The promotional ad may be selected to redirect the user’s attention to other content available from the platform server 104 to prevent or reduce the likelihood of the user engaging with content from a different platform (e.g., provided by another platform’s server). In this manner, the promotional ad recommendation algorithm selects promotional advertisements that correspond to the interests of the user based on the user’s interaction information and other preference signals.

The promotional ad may be determined using a promotional ad recommendation algorithm, which may be adapted to recommend other content from the platform which is likely to be of interest to the user. The promotional ad may therefore correspond to the interests of the user, and may be particular to each user, or based on user demographic, or the like.

Step 306 may include providing or otherwise identifying the determine promotional ad to the requesting media player device 106A. If only identified, the media player device 106A may retrieve the identified promotional ad from another suitable source, such as an advertising server, another data store of the platform, or the like.

Step 308 may include receiving advertisement interaction information corresponding to user interaction with the provided or otherwise identified promotional ad of step 304. User interaction with the promotional ad may indicate whether and/or how the user interacted with the promotional ad. For example, if the user watches the promotional ad, then shifts to the promoted content from current content, then it can be inferred that the promotional ad was effective to retain the user’s interest. For further example, if a user bookmarks the promoted content to watch later (e.g., adds to a watch list), that may be an indication that the promotional ad was effective. Other relevant user interaction with the promotional ad may include clicking or otherwise selecting the content recommended by the promotional ad (the promoted content), watching the promoted content later, allowing the promotional ad to fully play, or any other suitable metric. In some examples, determining relevant user interaction with the promotional ad may require some time (minutes, hours, days, weeks, etc.) to track advertisement interaction information, for example if the user watches the promoted content at a later time.

Step 310 may include refining or otherwise updating the promotional ad recommendation algorithm based on the received advertisement interaction information. The advertisement interaction information may provide insights to identify which recommendations resonate most with viewers as a whole, based on demographics, and/or for individual viewers, and the algorithm can be updated accordingly. The promotional ad recommendation algorithm logic and placement strategy may be continuously adjusted to improve effectiveness (e.g., more user retention on the platform) over time. That is, steps 308 and 310 may be continually repeated.

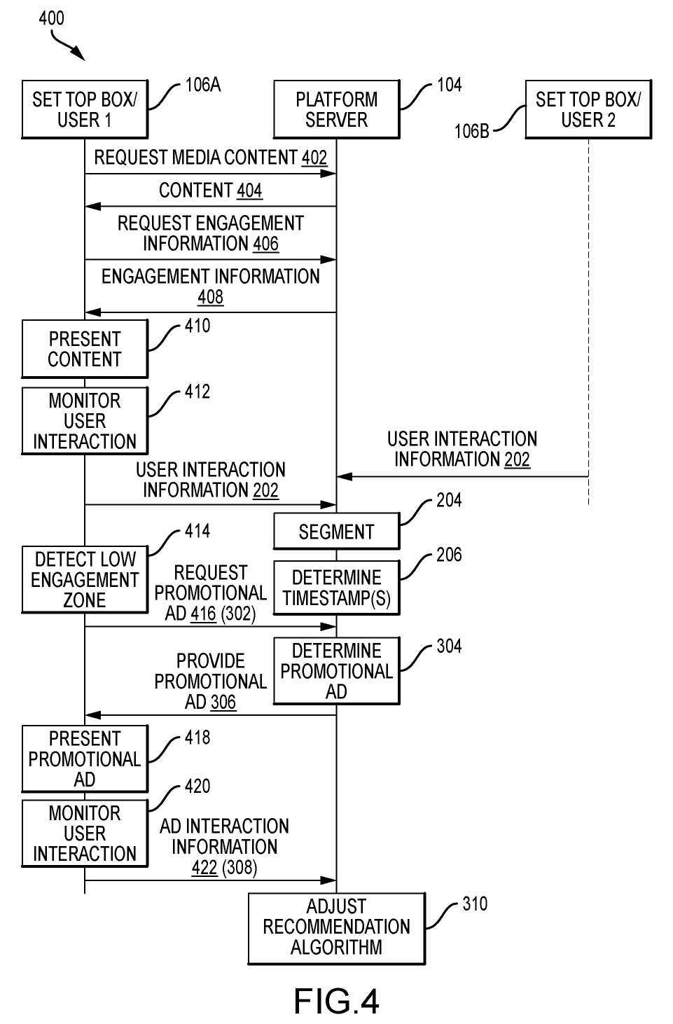

Referring to FIG. 4, an exemplary method 400 incorporating the user engagement method 200 and platform promotion method 300 is illustrated. The method 400 may be implemented by the media platform server 104 and one or more playback devices 106A-B. In the illustrated example, each playback device corresponds to a unique user. Other variations may be suitably implemented, for example multiple users per device, multiple devices per user, and/or the like.

At step 402, the media player device 106A may request a first media content from the media platform server 104, and at step 404 the media platform server 104 may provide the first media content.

At step 406, the media player device 106A may request zone segmentation information. At step 408, the media platform server 104 may provide the requested zone segmentation information, which may include zone segmentation information for the first media content and/or a user-specific algorithm. For example, step 408 may provide the zone segmentation information determined by step 204 of the user engagement method 200. For further example, step 408 may include step 208 of the user engagement method 200. In some embodiments, the zone segmentation information may be provided by the media platform server 104 to the media player device 106A unrequested, with the media content in step 404, or at any other suitable time. In some examples, the zone segmentation information provided at step 408 includes a user‑specific engagement zone algorithm that the media player device 106A can execute locally to detect low‑engagement zones during ongoing playback of the first media content.

At step 410, the media player device 106A may present the first media content to the user. At step 412, the media player device 106A monitors, for example using processor 184 and via one or more user interfaces (e.g., I/O 182), the user interaction with the media content. For example, step 412 may include the media player device 106A determining whether and/or how much the user fast forwards, rewinds, skips, pauses, etc. as described above, based on commands received by I/O 182.

The media platform server 104 may receive the monitored user interaction information from the media player device 106A, for example according to step 202 as described above. The media platform server 104 may receive user interaction information from multiple media player devices 106A-B, for example to more globally segment a media content and/or to determine or update engagement zone information for multiple users.

The media platform server 104 may determine the zone segmentation information based on the received user interaction information, for example according to step 204 as described above. The media platform server 104 may determine the low engagement zone timestamp(s), for example according to step 206 as described above. The media platform server 104 may, in some cases, determine a suitable timestamp for insertion of a promotional advertisement, as also described above with respect to step 206.

At step 414, the media player device 106A may detect, for example using processor 184, a low engagement zone, for example according to the engagement zone segmentation information provide in step 408 (e.g., step 208). Step 414 may include observing upcoming or current timestamps identifying low-engagement zones in the first media content (e.g., based on a more global segmentation of the content), analyzing user interactions using the provided algorithms, parameters, machine learning models, or the like that are specific to the user, or the like. In some embodiments, the detection at step 414 may be performed entirely on the media player device 106A using the locally collected user interactions, without requiring precomputed engagement zone segmentation from the media platform server 104.

In some embodiments, during step 204 the media platform server 104 may determine an engagement zone algorithm or train a machine learning model based on the received user interaction information, where the engagement zone algorithm or machine learning model is tailored to a particular user. The engagement zone information may include parameters, variables, node weights, or other data representing the engagement zone algorithm or machine learning model. The media platform server 104 may provide this user‑specific engagement zone algorithm or machine learning model to the playback device 106A, for example as part of the engagement zone information provided in step 208. The playback device 106A may execute the received engagement zone algorithm or machine learning model locally, using the collected user interactions for the first media content, to identify a low‑engagement zone of the first media content and thereby determine when the user has a low engagement or an increased likelihood of selecting media content from a source other than the media platform server 104.

At step 416, the media player device 106A may request a promotional advertisement from the media platform server 104, for example as described with respect to step 302. The media platform server 104 may determine a promotional ad, for example according to step 304 as described above. The media platform server 104 may provide the determined promotional ad or an identifier thereof to the media player device 106A, for example according to step 306 as described above.

At step 418, the media player device 106A may present the promotional advertisement to the user. The promotional advertisement may be presented prior to the end of the identified low engagement zone, prior to the low engagement zone, or other suitable location likely to prevent a user from leaving the platform due to the low engagement zone.

At step 420, the media player device 106A may monitor the user interaction with the promotional advertisement. Exemplary user interactions with respect to a promotional advertisements were described above. At step 422, the media player device 106A may provide the advertisement interaction information to the media platform server 104, for example as described with respect to step 308 above. The media platform server 104 may adjust, update, or otherwise refine the promotional advertisement recommendation algorithm based on the received advertisement interaction information, for example as described with respect to step 310 above.

According to the method 400, the media platform server 104 may continuously receive information about user interactions with content and with promotional advertisements, may determine and update (whether user specific or for larger user groups) low engagement zone information, and may improve promotional advertisement recommendations.

Each of the various features and systems described herein may be implemented in software and/or firmware that resides in non-transitory data storage for execution by one or more processors to perform the various automated processes described herein.

The general concepts set forth herein may be adapted to any number of alternate but equivalent embodiments. The term “exemplary” is used herein to represent one example, instance or illustration that may have any number of alternates. Any implementation described herein as “exemplary” is not necessarily to be construed as preferred or advantageous over other implementations, nor is it necessarily intended as a model that must be duplicated in other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A playback device configured to communicate with a media platform server over a network, the playback device comprising a user interface, a processor, and a non-transitory storage, wherein the non-transitory storage comprises computer-executable instructions that, when executed by the processor, perform an automated process that comprises:
presenting, to a user of the playback device, a first media content from the media platform server;
collecting, via the user interface, a plurality of interactions of the user corresponding to the first media content;
determining, using the processor, a low-engagement zone in the first media content based on the collected plurality of interactions of the user; and
inserting, in response to determining the low-engagement zone and during presentation of the first media content, a promotional advertisement related to a second media content available via the media platform server.

2. The playback device of claim 1, wherein determining the low-engagement zone comprises determining that the plurality of interactions of the user corresponds to an increased likelihood of the user selecting a third media content from a source other than the media platform server.

3. The playback device of claim 1, wherein the automated process further comprises receiving, from the media platform server, an engagement zone information, wherein determining the low-engagement zone is based on the engagement zone information.

4. The playback device of claim 3, wherein the engagement zone information corresponds to the interaction of a plurality of users with the first media content.

5. The playback device of claim 3, wherein the engagement zone information comprises an algorithm.

6. The playback device of claim 5, wherein the automated process further comprises collecting a plurality of previous interactions of the user corresponding to a fourth media content presented prior to the first media content, wherein the algorithm corresponds to the collected plurality of previous interactions.

7. The playback device of claim 5, wherein the algorithm comprises a machine learning model trained by the media platform server.

8. The playback device of claim 1, wherein the automated process further comprises:
requesting, from the media platform server and in response to determining the low-engagement zone, a platform-specific advertisement; and
receiving, from the media platform server, the promotional advertisement in response to the request for the platform-specific advertisement.

9. A playback device configured to communicate with a media platform server over a network, the playback device comprising a user interface, a processor, and a non-transitory storage, wherein the non-transitory storage comprises computer-executable instructions that, when executed by the processor, perform an automated process that comprises:
presenting, to a user of the playback device, a first media content received from the media platform server;
receiving, from the media platform server, an engagement zone information;
determining, using the processor and according to the engagement zone information, a low-engagement zone in the first media content; and
inserting, in response to determining the low-engagement zone and during presentation of the first media content, a promotional advertisement related to a second media content available via the media platform server.

10. The playback device of claim 9, wherein the engagement zone information corresponds to interactions of a plurality of users with the first media content.

11. The playback device of claim 9, wherein the automated process further comprises collecting, via the user interface, a plurality of interactions of the user corresponding to the first media content, wherein the engagement zone information comprises an algorithm, and wherein determining the low-engagement zone comprises executing, by the processor, the algorithm according to the collected plurality of interactions.

12. The playback device of claim 11, wherein the algorithm comprises a machine learning model trained by the media platform server.

13. The playback device of claim 11, wherein determining the low-engagement zone comprises determining that the plurality of interactions of the user corresponds to an increased likelihood of the user selecting a third media content from a source other than the media platform server.

14. The playback device of claim 9, wherein the automated process further comprises:
requesting, from the media platform server and in response to determining the low-engagement zone, a platform-specific advertisement; and
receiving, from the media platform server, the promotional advertisement in response to the request for the platform-specific advertisement.

15. A media platform system comprising a media server configured to communicate with a playback device over a network, the media server comprising a processor and a non-transitory storage, wherein the non-transitory storage comprises computer-executable instructions that, when executed by the processor, perform an automated process that comprises:
providing, via the network, a plurality of media content to the playback device;
receiving, from the playback device, a user interaction information, wherein the user interaction information describes a plurality of interactions of a user with the playback device corresponding to playback of the plurality of media content;
determining a user engagement algorithm based on the user interaction information, wherein the user engagement algorithm is operable to identify low-engagement zone of a first media content based on a plurality of interactions of the user with the playback device corresponding to playback of the first media content; and
providing, via the network, the user engagement algorithm to the playback device.

16. The media platform system of claim 15, wherein the low-engagement zone corresponds to an increased likelihood of the user selecting a second media content from a source other than the media platform system.

17. The media platform system of claim 15, wherein the automated process further comprises:
receiving a plurality of sets of user interaction information corresponding to playback of a third media content, wherein each of the sets of user interaction information is received from one of a plurality of other playback devices;
determining an engagement zone information corresponding to the plurality of sets of user interaction information; and
providing the engagement zone information to the playback device.

18. The media platform system of claim 15, wherein the automated process further comprises:
receiving, from the playback device, a request for a platform-specific advertisement;
determining, using a recommendation algorithm, a promotional advertisement in response to the request for the platform-specific advertisement; and
providing the promotional advertisement to the playback device.

19. The media platform system of claim 18, wherein the automated process further comprises:
receiving, from the playback device, an advertisement interaction information, wherein the advertisement interaction information describes an interaction of the user corresponding to the promotional advertisement; and
adjusting the recommendation algorithm based on the advertisement interaction information.

20. The media platform system of claim 15, wherein the user engagement algorithm comprises a machine learning model trained by the media platform system.
